(19) United States
(12) Patent Application Publication
(10) Pub. No.: US 2023/0172251 A1
(43) Pub. Date: Jun. 8, 2023

(54) A DIET COMPOSITION FOR ENHANCING LEAN BODY MASS AND MUSCLE MASS

(71) Applicants: UNIVERSITY OF SOUTHERN CALIFORNIA, Los Angeles, CA (US); UNIVERSITA DEGLI STUDI DE GENOVA, Genoa (IT)

(72) Inventors: Valter LONGO, Playa Del Rey, CA (US); Alessio NENCIONI, Genova (IT); Irene CAFFA, Alassio (IT)

(73) Assignees: UNIVERSITY OF SOUTHERN CALIFORNIA, Los Angeles, CA (US); UNIVERSITA DEGLI STUDI DE GENOVA, Genoa (IT)

(21) Appl. No.: 17/920,280

(22) PCT Filed: Apr. 22, 2021
(86) PCT No.: PCT/US2021/028599

§ 371 Date: Oct. 20, 2022

(30) Foreign Application Priority Data
Apr. 23, 2020 (IT) 102020000008740

(51) Int. Cl. A23L 33/00

(52) U.S. Cl. CPC A23L 33/30; A23L 33/40

(57) ABSTRACT

The use of and a method using a diet composition for enhancing lean body mass/muscle mass is provided. The diet composition includes a fasting-mimicking diet (FMD) component to be administered for a first time period of reduced calorie intake of 24 to 190 hours. The fasting-mimicking diet component provides less than 50% of the normal calorie intake of the subject with both protein restriction and sugar restriction. The diet composition can also include a re-feeding diet component to be administered for a second time period. Characteristically, the re-feeding diet component providing 60-100% of the normal calorie intake of the subject. Advantageously, the fasting-mimicking diet component and the re-feeding diet component are administered for multiple cycles.

### CROSS-REFERENCE TO RELATED APPLICATIONS

This application claims the benefit of Italian patent application Serial No. 102020000008740 filed Apr. 23, 2020, the disclosure of which is hereby incorporated in its entirety by reference herein.

### TECHNICAL FIELD

The present invention concerns the technical field of the nutraceutical industry. In particular, the invention relates to the use of a diet composition for enhancing lean body mass/muscle mass in a human subject in need thereof.

### BACKGROUND

Enhancing muscle mass is usually desirable in sport training/competitive sports/bodybuilding, but also in subjects with sarcopenia or cachexia (or a risk of developing them) and in frail older adults.

Sarcopenia and cachexia are conditions in which there is a tendency to lose muscle mass and which are frequently diagnosed during the natural history of different disorders, e.g. cancer, HIV, heart failure and frailty associated with aging.

Different approaches to enhance muscle mass have been proposed. These include muscle training coupled with protein- and calorie-rich diets, stimulation of mTOR by dietary supplements of specific amino acids (e.g., leucine), the use of androgens, of selective androgen receptor modulator (SARM), of hormones from the GH-IGF-1 axis, of anti-oxidants, as well as of antibodies against myostatin or activin receptor type IIA and IIB (e.g. bimagrumab).

However, all of these approaches are associated with possible side effects and several of them may ultimately increase cardiovascular risk and/or the risk of other aging-associated disorders, including cancer. Thus, “safe” strategies to enhance lean body mass to be applied in healthy or diseased subjects or in frail older adults are of strong interest and have a wide range of possible applications.

Previous studies in mice showed that periodic (bi-weekly) cycles of a fasting-mimicking diet (FMD) (using a product by L-Nutra) promote a lean bodyweight, improve health span, and promote tissue regeneration in mice.¹

Quite remarkably, the applicants found an age-dependent decline in Pax7 (whose expression is critical for muscle satellite cell biogenesis, survival, and self-renewal)² in 20-month-old mice. At the end of the FMD, Pax7 expression was reduced by 40% compared to that in control animals. However, 1 week after re-feeding, Pax7 expression in 20-month-old FMD group animals reached levels similar to those in 12-month-old ad libitum fed animals. Taken together, these changes are consistent with muscle regeneration and rejuvenation upon re-feeding. In fact, in both mice and humans, the FMD promoted an increase in the relative lean body mass². However, whether an FMD could also enhance absolute lean body mass/muscle mass has never been evaluated.

Accordingly, there is a need for dietary methods for enhancing lean body mass and muscle mass.

### SUMMARY

In at least one aspect, the use of a diet composition for enhancing lean body mass/muscle mass is provided. The diet includes a fasting-mimicking diet (FMD) component to be administered for a first time period of reduced calorie intake of 24 to 190 hours, The fasting-mimicking diet component provides less than 50% of the normal calorie intake of the subject with both protein restriction and sugar restriction. The diet also includes a re-feeding diet component to be administered for a second time period. The re-feeding diet component provides 60-100% of the normal calorie intake of the subject. Characteristically, the fasting-mimicking diet component and the re-feeding diet component are administered for multiple cycles.

In another aspect, the fasting-mimicking diet component includes rations for a fasting-mimicking diet to be administered for a first time period to a subject, the fasting-mimicking diet providing the subject with at most 50 percent of a subject's normal caloric intake for a first day to a fifth day, the fasting-mimicking diet being a low protein diet that provides less than 28 g of proteins on the first day and less than 18 g of proteins on the second to fifth days wherein the rations provide less than 30 g of sugar on the first day, less than 20 g of sugar on the second to fifth days, and less than 12 g of saturated fats on the first day and less than 6 grams of saturated fats on the second to fifth days.

In another aspect, the fasting-mimicking diet component includes proteins in an amount that is less than 15% of the total calories provided by the fasting-mimicking diet component.

In another aspect, the fasting-mimicking diet component includes sugars in an amount that is less than 15% of the total calories provided by the fasting-mimicking diet component.

In another aspect, the fasting-mimicking diet component provides the subject with 9 to 15 kcal/kg of body weight/day on day 1, and 6 to 10 kcal/kg of body weight/day on days 2 to 5.

In another aspect, the fasting-mimicking diet component provides the subject with 6 to 12 kcal/kg/body weight/day on day 1, and 4 to 8 kcal/kg/body weight/day on day 2 to 5.

In another aspect, the fasting-mimicking diet component provides the subject with 15 kcal/kg/body weight/day on day 1, and 8 kcal/kg/body weight/day on day 2 to 5.

In another aspect, the fasting-mimicking diet component comprises at least 60% calories from fatty acids, 2-5% calories from glycerol and up to 5% calories from plant-based proteins and a maximum of 35% calories from carbohydrates.

In another aspect, the fasting-mimicking diet component comprises complex carbohydrates from plant sources, which preferably comprise soy, rice or other cereals.

In another aspect, the fasting-mimicking diet provides at least 50% of the calories from fatty acids are from coconut oil and tree nuts. The latter preferably comprise walnuts, macadamia nuts and/or almonds.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1A is a diagram showing the weight of patients with HR+ breast cancer (HR+BC) undergoing FMD cycles in combination with endocrine therapy (ET) or ET+CDK4/6 inhibitors in the NCT03595540 trial (P6-UNIGE).

FIG. 1B is a diagram showing the hand grip of patients with HR+ breast cancer (HR+BC) undergoing FMD cycles in combination with endocrine therapy (ET) or ET+CDK4/6 inhibitors in the NCT03595540 trial (P6-UNIGE).

FIG. 1C is a diagram showing the phase angle value of patients with HR+ breast cancer (HR+BC) undergoing FMD cycles in combination with endocrine therapy (ET) or ET+CDK4/6 inhibitors in the NCT03595540 trial (P6-UNIGE).

FIG. 1D is a diagram showing the fat free mass of patients with HR+ breast cancer (HR+BC) undergoing FMD cycles in combination with endocrine therapy (ET) or ET+CDK4/6 inhibitors in the NCT03595540 trial (P6-UNIGE).

FIG. 1E is a diagram showing the fat mass of patients with HR+ breast cancer (HR+BC) undergoing FMD cycles in combination with endocrine therapy (ET) or ET+CDK4/6 inhibitors in the NCT03595540 trial (P6-UNIGE).

FIGS. 1F-1, 1F-2, 1G-1, and 1G-2 are CT scans that provide quantification of the muscle area of patient #1 and patient #3 from the NCT03595540 trial, before and after multiple FMD cycles.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, compositions, concentrations, amounts of diet components, and other conditions can be practiced with plus or minus 50 percent of the values indicated rounded to or truncated to two significant figures of the value provided in the examples. In a refinement, compositions, concentrations, amounts of diet components, and other conditions can be practiced with plus or minus 30 percent of the values indicated rounded to or truncated to two significant figures of the value provided in the examples. In another refinement, compositions, concentrations, amounts of diet components, and other conditions can be practiced with plus or minus 10 percent of the values indicated rounded to or truncated to two significant figures of the value provided in the examples.

The term “subject” refers to a human or animal, including all mammals such as primates (particularly higher primates), sheep, dog, rodents (e.g., mouse or rat), guinea pig, goat, pig, cat, rabbit, and cow.

The term “fasting-mimicking and enhancing diet” means a diet that mimics the effects of fasting typically by providing a subject with at most 50% of their normal caloric intake. The term “fasting-mimicking and enhancing diet” is sometimes simply referred to as a “fasting-mimicking diet.” These diets include those diets that have been referred to as fasting-mimicking diets. Examples of useful fasting-mimicking diet components are set forth in U.S. Pat. Pub. No. 2011/0118528 published May 19, 2011; U.S. Pat. Pub. No. 2013/0045215 published Feb. 21, 2013; U.S. Pat. Pub. No. 2013/0316948 published Nov. 28, 2013; U.S. Pat. Pub. No. 2014/0328863 published Nov. 6, 2014; U.S. Pat. Pub. No. 2015/0133370 published May 14, 2015; U.S. Pat. Pub. No. 2016/0331016 published Nov. 17, 2016; U.S. Pat. No. 8,865,646B2 issued Oct. 24, 2014; U.S. Pat. No. 8,728,815 issued May 20, 2014; U.S. Pat. No. 9,237,761 issued Jan. 19, 2016; U.S. Pat. No. 9,386,790 issued Jul. 12, 2016; U.S. Pat. No. 10,015,980 issued Jul. 10, 2018; and U.S. Pat. No. 10,172,839 issued Jan. 8, 2019; the entire disclosures of these patents and patent applications are hereby incorporated by reference.

Abbreviations:

“BC” means breast cancer.

“BMI” means body mass index.

“CT scan” means computed tomography scan.

“DD” means daily dose.

“ET” means endocrine therapy.

“FMD” means fasting-mimicking diet.

“HR+” means hormone receptor-positive.

“MRI” means magnetic resonance imaging.

In an embodiment, the use of and a method of using a diet composition for enhancing lean body mass/muscle mass in a human subject in need thereof is provided. Therefore, the method can include a step of identifying a subject in need of enhancing lean body mass/muscle mass. Typically, lean body mass is the human subject's total weight minus the weight from body fat. The Boer formula can be used to estimate lean body mass estimation from a subject's height and weight. Though expensive, MRI can be used to determine total body fat. Moreover, a subject in need of lean body mass/muscle mass enhancement can be determined by a physical examination by a medical professional. The diet composition includes a fasting-mimicking diet (FMD) component to be administered (or provided to the subject) for a first period of reduced caloric intake of 24 to 190 hours, the fasting-mimicking diet component providing less than 50% of the normal calorie intake of the subject with both protein restriction and sugar restriction. In a refinement, the diet composition includes a re-feeding diet component to be administered for a second time period, the re-feeding diet component providing 60-100% of the normal calorie intake of the subject. Advantageously, the fasting-mimicking diet component and the re-feeding diet component are administered for multiple cycles.

In a refinement, the first time period is from 48 to 150 hours. In a further refinement, the first time period is about 120 hours. In a refinement, the second time period is from 5 to 60 days or longer. In a further refinement thereof, the second time period is 25-26 days.

In a variation, the fasting-mimicking diet component provides 10-50% of the normal calorie intake of the subject.

In some variations, the fasting-mimicking diets set forth herein provide a subject at most, in increasing order of preference, 75%, 50%, 40%, 30%, or 10% of the subject's normal caloric intake or the daily recommended caloric intake for a subject. In a refinement, the fasting-mimicking diet component provides 10-50% of the normal calorie intake of the subject. In a further refinement, the fasting-mimicking diet component provides 10-25% of the normal calorie intake of the subject. In yet a further refinement, the fasting-mimicking diet component provides 10-15% of the normal calorie intake of the subject. The subject's normal calorie intake is the number of kcal that the subject consumes to maintain his/her weight. The subject's normal caloric intake is the number of kcal that the subject consumes to maintain his/her weight. In a refinement, the subject's normal weight is the subject's weight the day before or on the day the FMD protocol is began. As used herein, the phrase “FMD protocol” means the steps of administering or providing the fasting-mimicking diet. The subject's normal caloric intake may be estimated by interviewing the subject or by consideration of a subject's weight. As a rough guide, the subject's normal calorie intake is on average 2000 to 3000 kcal/day for men and 1600 to 2400 kcal/day for women.

Characteristically, the fasting-mimicking diet component provides the subject, with at most 1160, 1000, 957, 700, 500, 300, or 100 kcal/day, in ascending order of preference. In one refinement, the fasting-mimicking diet component provides less than 1160 kcal/day. In a refinement, the fasting-mimicking diet component provides less than 800 kcal/day. In a further refinement thereof, the fasting-mimicking diet component provides less than 400Kcal/day. It should be appreciated that the fasting-mimicking diet component provides some minimal caloric intake since it is not a complete fasting protocol. For example, the fasting-mimicking diet component provides, in increasing order of preference, at least 50 kcal/day, at least 150 kcal/day, at least 200 kcal/day, at least 250 kcal/day, or at least 300 kcal/day. In a useful refinement, the fasting-mimicking diet component provides the subject with 100 to 1000 kcal/day.

Typically, the subject undergoes at least three cycles of reduced calorie intake (e.g., the fasting-mimicking diet). In a refinement, the human subject undergoes and/or is administered at least five cycles of reduced calorie intake (e.g., the fasting-mimicking diet).

Advantageously, the fasting-mimicking diet component includes foods with a high content of monounsaturated and polyunsaturated fats and a reduced content of proteins and sugars. In a refinement, the fasting-mimicking diet component includes greater than or equal to 40% of calories that come from fats. Moreover, the fasting-mimicking component comprises dietetic foods with a reduced calorie, sugar, and protein content but containing relatively high levels of unsaturated “good fats” and all necessary micronutrients to prevent malnutrition.

In a variation, the fasting-mimicking diet component provides the subject with a protein amount less than or equal to 36 g/day. In particular, the fasting-mimicking diet component provides the subject with a protein amount less than or equal to 36, 28, 20, 10, 5 or 0 g/day, in increasing order of preference. In a refinement, the fasting-mimicking diet component provides the subject with a protein amount greater than or equal to 0, 0.5, 1, 1.5, or 2 g/day, in increasing order of preference.

If carbohydrates are present in the fasting-mimicking diet component, they provide no more than half of the calories provided by the fasting-mimicking diet component. The fasting-mimicking diet component provides the subject with no more than 11 kcal/kg of body weight/day (in particular no more than 8, 5, or 2 kcal in increasing order of preference) and no more than 0.4 g proteins/kg of body weight/day (in particular no more than 0.3, 0.2 or 0.1 g in increasing order of preference).

In some variations, the fasting-mimicking diet provides the nutrients listed in Tables 1 and 2 for an 80-90 kg human subject, which are shown in Tables 1-2 below. It should be appreciated that practice in a range plus or minus 20% of the indicated value is contemplated and included in these variations.

TABLE 1
Summary of Nutrient in the FMD component

| | Day 1 | Days 2, 3, 4, 5 |
|---|---|---|
| Total calories | 1152 | 809 |
| Fats | 56% | 46% |
| Carbohydrates | 34% | 46% |
| of which sugars | 10% | 9% |
| Protein | 10% | 9% |

TABLE 2
Daily breakdown of components in the FMD component

| | | | | Days | | |
|---|---|---|---|---|---|---|
| | | | | 2, 3, 4, 5 | | |
| | | | | and any | | |
| | | | | additional | | mean |
| | Unit | Day 1 | % DD | days | % DD | % DD |
| Protein | g | 29 | | 18 | | |
| Fats | g | 72 | | 41 | | |
| Carbohydrates | g | 98 | | 91 | | |
| (by difference) | | | | | | |
| From sugars | g | 29 | | 17.6 | | |
| Dietary fiber | g | 22 | 86 | 14 | 56 | 62 |
| Calcium | mg | 604 | 60 | 426 | 43 | 46 |
| Iron | mg | 13 | 77 | 10 | 55 | 60 |
| Magnesium | mg | 387 | 97 | 230 | 58 | 65 |
| Phosphorus | mg | 390 | 39 | 276 | 28 | 30 |
| Potassium | mg | 2519 | 72 | 1795 | 51 | 55 |
| Sodium | mg | 2427 | 101 | 1750 | 73 | 79 |
| Zinc | mg | 7 | 46 | 4.2 | 28 | 32 |
| Copper | mg | 1.5 | 76 | 1.2 | 59 | 63 |
| Manganese | mg | 3 | 148 | 1.9 | 95 | 105 |
| Selenium | mg | 7 | 10 | 5.3 | 8 | 8 |
| Vit. A | IU | 39254 | 785 | 27549 | 551 | 598 |
| Vit. C | mcg | 236 | 393 | 138 | 229 | 261 |
| Vit. B1 | mg | 4 | 209 | 2.2 | 113 | 132 |
| Vit. B2 | mg | 3.8 | 191 | 2 | 109 | 126 |
| Vit. B3 | mg | 28.5 | 143 | 18 | 92 | 102 |
| (niacin) | | | | | | |
| Vit. B5 | mg | 1.2 | 12 | 1.0 | 10 | 10 |
| (pantothenic | | | | | | |
| acid) | | | | | | |
| Vit. B6 | mg | 4.0 | 200 | 2.2 | 111 | 129 |
| Vit. B9 | mg | 479 | 120 | 317 | 79 | 87 |
| (folate) | | | | | | |
| Vit. B12 | mcg | 16 | 227 | 16 | 227 | 227 |
| Vit. D | IU | 952 | 238 | 952 | 238 | 238 |
| Vit. E | mcg | 25 | 127 | 16 | 80 | 89 |
| Vit K | mg | 1795 | 2243 | 1110 | 1387 | 1559 |

DD = Daily dose

In a variation, the fasting-mimicking diet component provides the subject with 9 to 15 kcal/kg of body weight/day on day 1 and 6 to 10 kcal/kg of body weight/day on days 2 to 5. In a refinement, the fasting-mimicking diet component provides the subject with 6 to 12 kcal/kg/body weight/day on day 1 and 4 to 8 kcal/kg/body weight/day on days 2 to 5. In still another refinement, the fasting-mimicking diet provides the subject with 4.5 to 7 kcal/pound of body weight/day on day 1, followed by 3 to 5 kcal/pound of body weight/day for days 2 to 5. In yet another refinement, the fasting-mimicking diet provides the subject with 7 kcal/pound of body weight/day on day 1, followed by 4 kcal/pound of body weight/day for days 2-5. In another variation, the fasting-mimicking diet provides the subject with 3-6 kcal/pound of body weight/day on day 1 followed by 2-4 kcal/pound of body weight/day for days 2-4. In some variations, the fasting-mimicking diet includes 2 to 5% calories from glycerol. For example, the fasting-mimicking diet can include at least 60% calories from fatty acids, 2-5% calories from glycerol and up to 5% of calories from plant-based proteins (averaged over the days of the FMD diet protocol), and a maximum of 35%-40% (or 35%-40%) of calories from carbohydrates. Advantageously, the carbohydrates are complex carbohydrates from plant sources such as soy, rice, or other grains, and at least 50% of the calories from fatty acids are from coconut oil and tree nuts (e.g., macadamia nuts, walnuts, or almonds). Typically, the FMD protocol is administered on consecutive days.

In another variation, the fasting-mimicking diet component includes less than 30 g of sugar on day 1 and less than 20 g of sugar on days 2-5. The fasting-mimicking diet component includes less than 28 g of proteins on day 1 and less than 18 g of proteins on days 2-5, mostly or completely from plant-based sources. The fasting-mimicking diet component includes between 20 and 30 grams of monounsaturated fats on day 1 and 10-15 grams of monounsaturated fats on days 2-5. The fasting-mimicking diet component includes between 6 and 10 grams of polyunsaturated fats on day 1 and 3-5 grams of polyunsaturated fats on days 2-5. The fasting-mimicking diet component includes less than 12 g of saturated fats on day 1 and less than 6 grams of saturated fats on days 2-5. In a refinement, the fats on all days are derived from a combination of the following: Almonds, Macadamia Nuts, Pecans, Coconut, Coconut oil, Olive Oil and Flaxseed. In refinement, the FMD diet includes over 50% of the recommended daily value of dietary fiber on all days. In a further refinement, the amount of dietary fiber is greater than 15 grams per day on all five days. In a refinement, the diet should contain 12-25 grams of glycerol per day, optionally on day 1 and on days 2-5. In a refinement, glycerol is provided at 0.1 grams per pound body weight/day on average over the days of the FMD protocol. In a variation, the fasting-mimicking diet component includes the all of or any combination of the following micronutrients (at least 95% non-animal based): over 5,000 IU of vitamin A per day (days 1-5); 60-240 mg of vitamin C per day (days 1-5); 400-800 mg of Calcium per day (days 1-5); 7.2-14.4 mg of Iron per day (days 1-5); 200-400 mg of Magnesium per day (days 1-5); 1-2 mg of copper per day (days 1-5); 1-2 mg of Manganese per day (days 1-5); 3.5-7 mcg of Selenium per day (days 1-5); 2-4 mg of Vitamin B1 per day (days 1-5); 2-4 mg of Vitamin B2 per day (days 1-5); 20-30 mg of Vitamin B3 per day (days 1-5); 1-1.5 mg of Vitamin B5 per day (days 1-5); 2-4 mg of Vitamin B6 per day (days 1-5); 240-480 mcg of Vitamin B9 per day (days 1-5); 600-1000 IU of Vitamin D per day (days 1-5); 14-30 mg of Vitamin E per day (days 1-5); over 80 mcg of Vitamin K per day (days 1-5); 16-25 mcg Vitamin B12 are provided during the entire 5-day period; 600 mg of Docosahexaenoic acid (DHA, algae-derived) are provided during the entire 5-day period. The FMD diet provides high micronutrient content mostly (i.e., greater than 50 percent by weight) from natural sources including: Kale, Cashews, Yellow Bell Pepper, Onion, Lemon Juice, Yeast, Turmeric. Mushroom, Carrot, Olive Oil, Beet Juice, Spinach, Tomato, Collard, Nettle, Thyme, Salt, Pepper, Vitamin B12 (Cyanocobalamin), Beets, Butternut Squash, Oregano, Tomato Juice, Orange Juice, Celery, Romaine Lettuce, Cumin, Orange Rind, Citric Acid, Nutmeg, Cloves, and combinations thereof.

In another variation, the fasting-mimicking diet component provides 1, 2, 3, 4, or 5 servings of soup compositions per day of the FMD protocol. In a refinement, the soup compositions each typically provide from 90 to 120 kcal per serving, 1 to 5 grams of fat, 15 to 30 grams of carbohydrates, and 2 to 7 grams of protein Examples of soup composition include but are not limited to a mushroom-containing soup composition, a tomato-containing soup composition, a quinoa-containing minestrone soup composition, a bean-containing minestrone soup composition, a pumpkin-containing soup composition, a butternut squash-containing soup composition, a black bean-containing soup composition, a butternut squash with quinoa composition, and a spinach with white bean soup composition, and combinations thereof (many of the soup compositions are set forth in U.S. patent application Ser. No. 15/432,803; the entire disclosure of which is hereby incorporated by reference.) The fasting-mimicking diet component can also provide 1, 2, 3, 4, or 5 nutrition bars per day of the FMD protocol. In a refinement, the nutrition bars each provide from 150 to 300 kcal per serving, 15 to 30 grams of fat, 5 to 20 grams of carbohydrates, and 2 to 7 grams of protein. In a refinement, the fasting-mimicking diet component also provides 1, 2, or 3 nutrition bars per day. Examples of nutrition bars are nut-containing bars and cocoa-containing nutrition bar as set forth in U.S. patent application Ser. No. 15/432,803 and in U.S. patent application Ser. No. 16/680,911; the entire disclosures of which is hereby incorporated by reference.

U.S. patent application Ser. No. 15/432,803 provides a diet package that can be used for the fasting-mimicking component herein; the entire disclosure of which is hereby incorporated by reference. This diet package includes various components such as soup mixes, fast bars, and crackers, all which mimic fasting. Although the prior art fasting-mimicking diet components work well, compositions with improved formulation and appeal taste properties are desired. The Prolon® fasting-mimicking diet is an example of the diet package described in U.S. patent application Ser. No. 15/432,803; the entire disclosure of which is hereby incorporated by reference. In a variation, the fasting-mimicking diet package includes a kale cracker composition, a first vegetable soup composition, a mushroom soup composition, a tomato soup composition, a quinoa-containing minestrone soup composition, a bean-containing minestrone soup composition, and a pumpkin soup composition. Characteristically, the daily meal portions are packaged into meal servings or into a total daily serving to be divided into meals. In a refinement, the fasting-mimicking diet package further includes a fast bar as set forth above (e.g., a cocoa-containing fast bar), a first olive-containing composition, a first vegetable broth composition, a tea composition that includes spearmint, an energy drink composition, a micro-nutritional composition, and algal oil composition. In a further refinement, the fasting-mimicking diet package further includes a second olive-containing composition, a second vegetable broth composition, a tea composition that includes spearmint, lemon peel, and lemongrass, and a tea composition that includes hibiscus.

In some variation, a fasting-mimicking diet package as described in U.S. patent application Ser. No. 15/432,803, includes a kale cracker composition, a first vegetable broth composition, a mushroom soup composition, a tomato soup composition, a quinoa-containing minestrone soup composition, a bean-containing minestrone soup composition, and a pumpkin soup composition. Characteristically, the daily meal portions are packaged into meal servings or into a total daily serving to be divided into meals. In a refinement, the fasting-mimicking diet package further includes a nut-containing nutrition bar, a cocoa-containing nutrition bar, a first olive-containing composition, a first vegetable broth composition, a tea composition that includes spearmint, an energy drink composition, a micro nutritional composition, and an algal oil composition. In a further refinement, the fasting-mimicking diet package further includes a second olive-containing composition, a second vegetable broth composition, a tea composition that includes spearmint and lemon, and a tea composition that includes hibiscus. It should be appreciated that each of the soup, broth, tea and energy compositions set forth herein are designed to have added water when consumed. Table 3 provides a meal schedule for the fasting-mimicking diet package of U.S. patent application Ser. No. 15/432,803.

TABLE 3
Meal Schedules of fasting-mimicking diet component
from U.S. patent application Ser. No. 15/432,803.

| COMPONENTS (single | MEAL PLAN - PROLON US | | | | |
|---|---|---|---|---|---|
| servings) | DAY 1 | DAY 2 | DAY 3 | DAY 4 | DAY 5 |
| nut-containing nutrition bar | 2 | 1 | 1 | 1 | 1 |
| (L-Bar Nut based) | | | | | |
| cocoa-containing nutrition | 1 | 1 | — | 1 | — |
| bar (L-Bar ChocoCrisp) - .83 | | | | | |
| oz. | | | | | |
| First olive-containing | 1 | 1 | — | 1 | — |
| composition (Sea Salt) - 0.73 | | | | | |
| oz | | | | | |
| Second olive-containing | — | 1 | — | 1 | — |
| composition (Garlic) - 0.73 | | | | | |
| oz | | | | | |
| kale cracker composition, | 1 | — | 1 | — | 1 |
| (35 g) | | | | | |
| vegetable soap composition | — | — | — | 1 | — |
| mushroom soap composition | — | 1 | — | — | — |
| tomato soap composition | 1 | — | 1 | — | 1 |
| quinoa-containing | — | 1 | — | 1 | — |
| minestrone soup composition | | | | | |
| bean-containing minestrone | 1 | — | 1 | — | 1 |
| soup composition | | | | | |
| pumpkin soup composition, | — | — | — | — | — |
| First vegetable broth | — | — | — | — | — |
| composition | | | | | |
| Second vegetable broth | — | — | — | — | — |
| composition (chicken) | | | | | |
| Energy Drink | — | 1 | 1 | 1 | 1 |
| Tea - Spearmint | 1 | 1 | 1 | 1 | 1 |
| Tea - Lemon Spearmint | 1 | 1 | 1 | 1 | 1 |
| Tea - Hibiscus | — | 2 | 2 | 2 | 2 |
| Algal oil | 1 | — | — | — | 2 |
| NR-1 | 2 | 1 | 1 | 1 | 1 |

In another variation of a fasting-mimicking diet package, diet package 10 includes a nut-containing nutrition bar, a cocoa-containing nutrition bar, a first olive-containing composition, a kale cracker composition, a vegetable soup composition, a first vegetable broth composition, a tea composition that includes spearmint, an energy drink composition, a micro nutritional composition, and an algal oil composition. Characteristically, the daily meal portions are packaged into meal servings or into a total daily serving to be divided into meals. This diet package also includes daily meal portions for a predetermined number of days as set forth above, with the daily meal portions being packaged into meal servings or into a total daily serving to be divided into meals. In a refinement, the fasting-mimicking diet package further includes a mushroom soup composition, a tomato soup composition, a quinoa-containing minestrone soup composition, and a pumpkin soup composition. In a further refinement, the fasting-mimicking diet package further includes a second olive-containing composition, a second vegetable broth composition, a bean-containing minestrone soup composition, a tea composition that includes spearmint and lemon, and a tea composition that includes hibiscus.

As set forth above, the fasting-mimicking diet packages include specific meal components. Typically, compositions are as follows. The nut-containing nutrition bar includes almond meal and macadamia nuts. The cocoa-containing nutrition bar includes almond butter, almonds, and brown rice crispy (e.g., brown puffed rice). The mushroom soup composition includes brown rice powder, carrots, inulin, and mushrooms. The bean-containing minestrone soup composition includes white beans, cabbage, and potatoes. The first vegetable broth composition includes carrots, maltodextrin, celery, spinach, and tomatoes. The second vegetable broth composition includes carrots, maltodextrin, celery, spinach, soy lecithin, and tomatoes. The energy drink composition includes glycerin and water. The algal oil composition includes schizocatrium algae oil. The micronutrient composition includes beet root powder, calcium carbonate, carrots, collard leaf, kale leaf, and tomatoes. In a refinement, the micronutrient composition includes Vit A, Vit C, Ca, Fe, Vit D3, Vit E, Vit K, Vit B1, Vit B2, Vit B3, Vit B5, Vit B6, Vit B7, Vit B9, Vit B12, Cr, Cu, I, Mg, Mn, Mo, Se, and Zn.

In a refinement, the nut-containing nutrition bar (L-Bar Nut based) includes almond meal and macadamia nuts. In a refinement, the nut-containing nutrition bar (L-Bar Nut based) includes almond meal preferably in an amount of 20 to 35 weight %; coconut preferably in an amount of 2 to 10 weight %; coconut oil preferably in an amount of 1 to 8 weight %; flax seed meal preferably in an amount of 1 to 8 weight %; honey preferably in an amount of 10 to 30 weight %; macadamia nuts preferably in an amount of 10 to 30 weight %; pecans preferably in an amount of 10 to 25 weight %; salt preferably in an amount of 0.1 to 0.8 weight %; and optionally vanilla preferably in an amount of 0.1 to 0.2 weight %.

In a refinement, the cocoa-containing nutrition bar (L-Bar Choc® Crisp) includes almond butter, almonds, and brown rice crispy (PGP10235). In a refinement, the cocoa-containing nutrition bar (L-Bar ChocoCrisp) includes almond butter preferably in an amount of 10 to 25 weight %; almonds preferably in an amount of 3 to 12 weight %; brown rice crispy (PGP10235) preferably in an amount of 10 to 25 weight %; brown rice syrup preferably in an amount of 2 to 8 weight %; chocolate liquor preferably in an amount of 1 to 4 weight %, cocoa butter preferably in an amount of 0.4 to 1.6 weight %; cocoa powder preferably in an amount of 4 to 12 weight %; fiber syrup SF75 preferably in an amount of 18 to 38 weight %, flaxseed oil preferably in an amount of 1 to 3 weight %; salt preferably in an amount of 0.1 to 0.4 weight % and sugar preferably in an amount of 1 to 6 weight %.

In a refinement, the first olive-containing composition (sea salt version) includes olives, olive oil, and sea salt. In a refinement, the first olive-containing composition (sea salt) includes lactic acid preferably in an amount of 0.3 to 1 weight %; oil (olive) preferably in an amount of 2 to 6 weight %; olives (raw, green pitted) preferably in an amount of 50 to 97 weight %; salt (reg., kosher, sea salt) preferably in an amount of 0.8 to 3 weight %; and thyme preferably in an amount of 0.1 to 0.5 weight %.

In a refinement, the second olive-containing composition (garlic version) includes olives, olive oil, and garlic. In a refinement, the second olive-containing composition (garlic) includes garlic preferably in an amount of 0.1 to 0.6 weight %; lactic acid preferably in an amount of 0.3 to 1 weight %; oil (olive) preferably in an amount of 2 to 6 weight %; olives (raw, green pitted) preferably in an amount of 50 to 97 weight %; salt (reg., kosher, sea salt) preferably in an amount of 0.8 to 3 weight %; thyme preferably in an amount of 0.1 to 0.5 weight %.

In a refinement, the kale cracker composition includes kale, almonds, tapioca flour, and optionally sesame seeds. In another refinement, the kale cracker composition includes almonds preferably in an amount of 15 to 40 weight %; black pepper preferably in an amount of 0.1 to 0.4 weight %; chia seeds preferably in an amount of 3 to 10 weight %; chili pepper preferably in an amount of 0.4 to 1.2 weight %; cumin seeds preferably in an amount of 0.3 to 0.9 weight %; flax seeds preferably in an amount of 3 to 10 weight %; garlic preferably in an amount of 0.02 to 0.04 weight %; kale preferably in an amount of 2 to 6 weight %; oil (sun flower) preferably in an about of 2 to 7 weight %; onion (powder, minced) typically in an amount of 0.3 to 0.9 weight %; oregano preferably in an amount of 0.01 to 0.06 weight %; salt preferably in an amount of 1 to 4 weight %; sesame seeds preferably in an amount of 15 to 35 weight %; sugar (coconut) preferably in an amount of 1 to 5 weight %; tapioca flour preferably in an amount of 10 to 30 weight %; vinegar (coconut) preferably in an amount of 1 to 4 weight %; water (purified) preferably in an amount of 2 to 12 weight %; and yeast extract preferably in an amount of 0.3 to 1 weight %.

In another refinement, the kale cracker composition includes kale, flax seeds golden, sesame seeds, and sunflower seeds. In another refinement, the apple cider vinegar preferably in an amount 1 to 3 weight %; black pepper preferably in an amount of 0.4 to 1.3 weight %; cashews preferably in an amount of 4 to 13 weight %; dill weed preferably in an amount of 0.4 to 1.3 weight %; flax seeds golden preferably in an amount of 13 to 40 weight %; hemp seeds preferably in an amount of 0.7 to 2 weight %; kale preferably in an amount of 14 to 42 weight %; onion, white, dried, (powder, minced) preferably in an amount of 0.5 to 1.6 weight %; pumpkin seeds preferably in an amount of 0.7 to 2 weight %; salt (reg., kosher, sea salt) preferably in an amount of 0.7 to 2 weight %; Sesame seeds preferably in an amount of 2 to 8 weight %; sunflower seeds preferably in an amount of 10 to 30 weight %; and yeast extract preferably in an amount of 1 to 5 weight %.

In a refinement, the vegetable soup compositions include onions, tomatoes, spinach, green tree extract, optionally rice flour, optionally brown rice powder, optionally carrots, and optionally inulin, leeks, In a refinement, the vegetable soup composition includes basil (whole leaf, dried) preferably in an amount of 0.3 to 0.9 weight %; brown rice powder (whole grain) preferably in an amount of 3 to 12 weight %; carrot (dehydrated, puffed, powder, pieces) preferably in an amount of 4 to 14 weight %; green tea extract preferably in an amount of 0.02 to 0.06 weight %; inulin preferably in an amount of 5 to 15 weight %; leeks (granules −10+40) preferably in an amount of 1 to 5 weight %; oil (olive) preferably in an amount of 1 to 6 weight %; onion (powder, minced) preferably in an amount of 4 to 15 weight %; parsley preferably in an amount of 0.3 to 0.8 weight %; red bell peppers preferably in an amount of 1 to 5 weight %; rice flour preferably in an amount of 18 to 50 weight %; salt preferably in an amount of 2 to 7 weight %; spinach (leaf, powder) preferably in an amount of 0.4 to 1.5 weight %; tomatoes (fruit powder, sun dried, granules) preferably in an amount of 4 to 14 weight %; yeast extract preferably in an amount of 0.5 to 1.8 weight %. In the vegetable soup composition and any of the compositions set forth herein having rice flour, the rice flour can be glutinous or non-glutinous, milled or unmilled.

In another refinement, the vegetable soup composition includes carrots, inulin, leeks, onions and rice flour. In a refinement, the vegetable soup composition includes basil, whole leaf, dried preferably in an amount of 0.3 to 1 weight; carrot (dehydrated, puffed, powder, pieces) preferably in an amount of 4 to 12 weight; inulin preferably in an amount of 6 to 18 weight; leeks in an amount of 1 to 5 weight; oil (olive) preferably in an amount of 1 to 3 weight; Onion, white, dried, (powder, minced) preferably in an amount of 10 to 30 weight; parsley preferably in an amount of 0.3 to 1 weight; potato preferably in an amount of 1 to 5 weight; red pepper preferably in an amount of 1 to 6 weight; rice flour in an amount of 13 to 40 weight; salt (reg., kosher, sea salt) in an amount of 4 to 12 weight; spinach (leaf, powder) preferably in an amount of 0.2 to 1 weight; and tomatoes, (fruit powder, sun dried granules) preferably in an amount of 3 to 13 weight.

In a refinement, the mushroom soup composition includes mushrooms, green tea extract, optionally brown rice powder, optionally carrots, and optionally inulin. In a refinement, the mushroom soup composition includes brown rice powder (whole grain) preferably in an amount of 10 to 30 weight %; carrot (dehydrated, puffed, powder, pieces) preferably in an amount of 3 to 12 weight %; green tea extract preferably in an amount of 0.02 to 0.06 weight %; inulin preferably in an amount of 3 to 12 weight %; mushrooms (European mix, powder, pieces) preferably in an amount of 6 to 18 weight %; oil (olive) preferably in an amount of 1 to 6 weight %; onion preferably in an amount of powder, minced) preferably in an amount of 3 to 12 weight %; parsley preferably in an amount of 0.1 to 0.5 weight %; rice flour preferably in an amount of 18 to 50 weight %; salt preferably in an amount of 2 to 8 weight %; yeast extract preferably in an amount of 0.5 to 1.5 weight %.

In another refinement, the mushroom soup composition includes carrots, inulin, mushrooms, onions, and rice flour. In another refinement, the mushroom soup composition includes carrot (dehydrated, puffed, powder, pieces) preferably in an amount of 7 to 22 weight %; inulin preferably in an amount of 7 to 22 weight %; mushrooms (European mix), (powder & pieces) dehydrated preferably in an amount of 7 to 22 weight %; oil (olive) preferably in an amount of 0.6 to 2 weight %; Onion, white, dried, (powder, minced) preferably in an amount of 7 to 22 weight %; parsley preferably in an amount of 0.3 to 0.9 weight %; potato preferably in an amount of 0.6 to 2 weight %; rice flour preferably in an amount of 15 to 45 weight %; salt (reg., kosher, sea salt) preferably in an amount of 6 to 18 weight %; and yeast extract preferably in an amount of 0.7 to 2.2 weight %.

In a refinement, the tomato soup composition includes tomatoes, green tea extract, optionally inulin, and optionally onions. In a refinement, the tomato soup composition (new) includes basil (whole leaf, dried) preferably in an amount of 0.2 to 0.7 weight %; brown rice powder (whole grain) preferably in an amount of 1 to 5 weight %; green tea extract preferably in an amount of 0.02 to 0.06 weight %; inulin preferably in an amount of 7 to 20 weight %; oil (olive) preferably in an amount of 3 to 9 weight %; onion preferably (powder, minced) preferably in an amount of 4 to 12 weight %; parsley preferably in an amount of 0.1 to 0.6 weight %; rice flour preferably in an amount of 18 to 50 weight %; salt preferably in an amount of 2 to 9 weight %; tomatoes (fruit powder, sun-dried, granules) preferably in an amount of 12 to 36 weight %; and yeast extract preferably in an amount of 0.5 to 3 weight %.

In another refinement, the tomato soup composition includes tomatoes, inulin, olives, onions, potatoes, and rice flour. In still another refinement, the tomato soup composition includes basil, whole leaf, dried preferably in an amount of 0.3 to 1 weight %; inulin preferably in an amount of 6 to 18 weight %; oil (olive) preferably in an amount of 4 to 14 weight %; onion, white, dried, (powder, minced) preferably in an amount of 8 to 24 weight %; parsley preferably in an amount of 0.3 to 0.9 weight %; potato preferably in an amount of 6 to 18 weight %; rice flour preferably in an amount of 9 to 27 weight %; salt (reg., kosher, sea salt) preferably in an amount of 4 to 14 weight %; tomatoes, (fruit powder, sun-dried granules) preferably in an amount of 8 to 24 weight %; and yeast extract preferably in an amount of 0.7 to 2.2 weight %.

In a refinement, the quinoa-containing minestrone soup composition includes quinoa, green tea extract, optionally olive oil, optionally cabbage, optionally potatoes, optionally rice flour, and optionally tomatoes and optionally no turmeric. In a refinement, the quinoa-containing minestrone soup composition includes basil (whole leaf, dried preferably in an amount of 0.7 to 2 weight %; broccoli powder preferably in an amount of 0.6 to 2 weight %; cabbage white (flakes) preferably in an amount of 3 to 10 weight %; carrot (dehydrated, puffed, powder, pieces) preferably in an amount of 3 to 10 weight %; celery preferably in an amount of 1 to 4 weight %; celery seeds (powder) preferably in an amount of 0.07 to 0.2 weight %; garlic preferably in an amount of 0.7 to 2 weight %; green tea extract preferably in an amount of 0.02 to 0.06 weight %; inulin preferably in an amount of 1 to 5 weight %; leeks (granules −10+40), preferably in an amount of 0.7 to 2 weight %; oil (olive) preferably in an amount of 0.6 to 2 weight %; onion (powder, minced) preferably in an amount of 2 to 8 weight %; peas preferably in an amount of 3 to 10 weight %; potato preferably in an amount of 7 to 20 weight %; quinoa preferably in an amount of 7 to 20 weight %; rice flour preferably in an amount of 7 to 20 weight %; salt, preferably in an amount of 1 to 6 weight %; spinach (leaf, powder) preferably in an amount of 0.5 to 2 weight %; tomatoes (fruit powder, sun dried, granules) preferably in an amount of 2 to 6 weight %; yeast extract preferably in an amount of 0.6 to 2 weight %; zucchini (powder, diced) preferably in an amount of 2 to 8 weight %.

In another refinement, the quinoa-containing minestrone soup includes quinoa, cabbage, potatoes, and rice flour. In still another refinement, the quinoa-containing minestrone soup includes basil, whole leaf, dried preferably in an amount of 0.7 to 2.2 weight %; broccoli powder preferably in an amount of 0.7 to 2.2 weight %; cabbage white (flakes) preferably in an amount of 0.6 to 2.2 weight %; carrot (dehydrated, puffed, powder, pieces) preferably in an amount of 3 to 10 weight %; celeriac preferably in an amount of 2 to 6 weight %; celery seeds powder preferably in an amount of 0.6 to 1.8 weight %; garlic preferably in an amount of 1 to 3 weight %; Onion, white, dried, (powder, minced) preferably in an amount of 3 to 9 weight %; peas preferably in an amount of 3 to 10 weight %; potato preferably in an amount of 6 to 20 weight %; quinoa preferably in an amount of 8 to 23 weight %; rice flour preferably in an amount of 7 to 22 weight %; salt (reg., kosher, sea salt) preferably in an amount of 2 to 7 weight %; savoy cabbage preferably in an amount of 3 to 10 weight %; spinach (leaf, powder) preferably in an amount of 0.7 to 2.2 weight %; turmeric preferably in an amount of 0.6 to 1.8 weight %; yeast extract preferably in an amount of 3 to 10 weight %; and zucchini (powder, diced) preferably in an amount of 1 to 5 weight %.

In a refinement, the bean-containing minestrone soup composition includes white beans (e.g., great northern beans), great tea extract, optionally cabbage, and optionally potatoes. In a refinement, the bean-containing minestrone soup composition includes beans (great northern) preferably in an amount of 3 to 10 weight %; cabbage white (flakes) preferably in an amount of 2 to 8 weight %; carrot (dehydrated, puffed, powder, pieces) preferably in an amount of 2 to 8 weight %; celery preferably in an amount of 1 to 4 weight %; green tea extract preferably in an amount of 0.02 to 0,06 weight %; inulin preferably in an amount of 2 to 10 weight %; leeks (granules −10+40) preferably in an amount of 2 to 7 weight %; oil (olive) preferably in an amount of 2 to 7 weight %; onion (powder, minced) preferably in an amount of 2 to 7 weight %; parsley preferably in an amount of 0.2 to 1 weight %; peas preferably in an amount of 3 to 9 weight %; potato preferably in an amount of 15 to 45 weight %; rice flour preferably in an amount of 6 to 18 weight %; salt preferably in an amount of 2 to 8 weight %; spinach (leaf, powder) preferably in an amount of 0.5 to 1.5 weight %; tomatoes (fruit powder, sun dried, granules) preferably in an amount of 2 to 7 weight %; and yeast extract preferably in an amount of 0.5 to 1.5 weight %.

In a refinement, the bean-containing minestrone soup composition includes brown beans, carrots, peas, potato, and rice flour. In another refinement, the bean-containing minestrone soup composition includes carrot (dehydrated, puffed, powder, pieces) preferably in an amount of 4 to 14 weight %; celeriac preferably in an amount of 1 to 5 weight %; celery preferably in an amount of 0.5 to 1.6 weight %; leeks preferably in an amount of 2 to 8 weight %; oil (olive) preferably in an amount of 2 to 8 weight %; Onion, white, dried, (powder, minced) preferably in an amount of 3 to 10 weight %; parsley preferably in an amount of 0.5 to 1.5 weight %; peas preferably in an amount of 5 to 18 weight %; potato preferably in an amount of 8 to 24 weight %; rice flour preferably in an amount of 5 to 18 weight %; salt (reg., kosher, sea salt) preferably in an amount of 4 to 14 weight %; spinach (leaf, powder) preferably in an amount of 0.5 to 1.5 weight %; tomatoes, (fruit powder, sun dried granules) preferably in an amount of 0.9 to 2.8 weight %; turmeric preferably in an amount of 0.3 to 1.2 weight %; and yeast extract preferably in an amount of 0.5 to 1.5 weight %.

In a refinement, the pumpkin soup composition includes pumpkin, green tree extract, optionally rice flour, optionally carrots, and optionally brown rice powder. In a refinement, the pumpkin soup composition includes (new) includes brown rice powder (whole grain) preferably in an amount of 3 to 9 weight %; carrot (dehydrated, puffed, powder, pieces) preferably in an amount of 2 to 8 weight %; green tea extract preferably in an amount of 0.02 to 0.06 weight %; inulin preferably in an amount of 2 to 10 weight %; oil (olive) preferably in an amount of 1 to 7 weight %; onion (powder, minced) preferably in an amount of 1.0 to 3 weight %; pumpkin powder preferably in an amount of 20 to 60 weight %; rice flour preferably in an amount of 15 to 45 weight %; salt preferably in an amount of 2 to 10 weight %; and yeast extract preferably in an amount of 0.3 to 1 weight %.

In a refinement, the first vegetable broth includes carrots, maltodextrin, celery, spinach, and tomatoes. In a refinement, the first vegetable broth includes carrot (dehydrated, puffed, powder, pieces) preferably in an amount of 6 to 18 weight %; celery preferably in an amount of 3 to 10 weight %; garlic preferably in an amount of 3 to 10 weight %; maltodextrin preferably in an amount of 8 to 25 weight %; oil (canola) preferably in an amount of 0.5 to 2 weight %; onion (powder, minced) preferably in an amount of 6 to 18 weight %; parsley preferably in an amount of 3 to 10 weight %; potato preferably in an amount of 1 to 3 weight %; salt preferably in an amount of 7 to 21 weight %; spinach (leaf, powder) preferably in an amount of 3 to 10 weight %; tomatoes (fruit powder, sun dried, granules) preferably in an amount of 6 to 18 weight %; and yeast extract preferably in an amount of 1 to 6 weight %.

In a refinement, the second vegetable broth (chicken flavoring) includes carrots, chicken flavoring, maltodextrin, celery, spinach, soy lecithin, and tomatoes. In a refinement, the second vegetable broth composition includes carrot (dehydrated, puffed, powder, pieces) preferably in an amount of 3 to 10 weight %; celery preferably in an amount of 3 to 12 weight %; garlic preferably in an amount of 3 to 9 weight %; maltodextrin preferably in an amount of 8 to 25 weight %; oil (canola) preferably in an amount of 0.5 to 2 weight %; onion preferably in an amount of powder, minced) preferably in an amount of 3 to 12 weight %; parsley preferably in an amount of 3 to 10 weight %; potato preferably in an amount of 1 to 6 weight %; salt preferably in an amount of 8 to 25 weight %; soy lecithin preferably in an amount of 0.5 to 3 weight %; spinach (leaf, powder) preferably in an amount of 3 to 12 weight %; tomatoes (fruit powder, sun-dried, granules) preferably in an amount of 6 to 18 weight %; xanthan gum preferably in an amount of 0.5 to 4 weight %; and yeast extract preferably in an amount of 4 to 12 weight %.

In a refinement, the energy drink composition includes glycerin preferably in an amount of 20 to 60 weight %; water (purified) preferably in an amount of 40 to 80 weight %.

In a refinement, the tea composition that includes spearmint includes spearmint leaves organic preferably in an amount of 70 to 100 weight %.

In a refinement, the tea composition that includes lemon and spearmint includes lemon myrtle organic preferably in an amount of 3 to 12 weight %; lemon peel organic preferably in an amount of 10 to 25 weight %; spearmint leaves organic preferably in an amount of 50 to 95 weight %.

In a refinement, the tea composition that includes hibiscus includes hibiscus tea leaves organic, preferably in an amount of 80 to 100 weight %.

In a refinement, the algal oil composition includes schizocatrium algae oil (DHA Omega-3), preferably in an amount of 80 to 100 weight %.

In a refinement, the nutrient replenishment composition (NR-1) includes beetroot powder, calcium carbonate, carrots, collard leaf, kale leaf, and tomatoes. In a refinement, the nutrient replenishment composition (NR-1) includes ascorbic acid preferably in an amount of 1 to 3 weight %; beet root powder preferably in an amount of 6 to 20 weight %; beta carotene preferably in an amount of 0.05 to 0.15 weight %; calcium carbonate preferably in an amount of 6 to 20 weight %; carrot (dehydrated, puffed, powder, pieces) preferably in an amount of 6 to 20 weight %; cholecalciferol preferably in an amount of 0.00 weight %; chromium Picolinate preferably in an amount of 0.00 weight %; collard leaf powder preferably in an amount of 6 to 20 weight %; cupric sulfate preferably in an amount of 0.01 to 0.06 weight %; cyanocobalamin, 0.00; Dl-alpha tocopherol acetate preferably in an amount of 0.3 to 1 weight %; ferrous fumarate preferably in an amount of 0.2 to 1 weight %; folic acid preferably in an amount of 0.00 weight %; kale leaf preferably in an amount of 6 to 20 weight %; magnesium stearate preferably in an amount of 1 to 6 weight %; manganese sulfate preferably in an amount of 0.04 to 0.08 weight %; niacinamide preferably in an amount of 0.3 to 1 weight %; pantothenic acid preferably in an amount of 0.1 to 0.6 weight %; phytonadione preferably in an amount of 0.00 weight %; potassium iodine preferably in an amount of 0 weight %; pyridoxine HCl preferably in an amount of 0.03 to 0.1 weight %; riboflavin preferably in an amount of 0.02 to 0.1 weight %; sodium molybdate preferably in an amount of 0.00 weight %; sodium selenate preferably in an amount of 0.00 weight %; spinach (leaf, powder) preferably in an amount of 6 to 20 weight %; thiamine mononitrate preferably in an amount of 0.02 to 0.1 weight %; tomatoes (fruit powder, sun dried, granules) preferably in an amount of 6 to 20 weight %; tribasic calcium phosphate preferably in an amount of 0.5 to 2 weight %; and zinc oxide preferably in an amount of 0.2 to 0.8 weight %.

In a variation, each of the components of the fasting-mimicking diet component diet, is substantially gluten-free (e.g., each component has less than 20 ppm gluten) or very low gluten (e.g., each component has 20-100 ppm). In other variations, each of the components are provided in a serving size from 20 to 60 g. In other variations, the nut-containing nutrition bar is provided in a serving size from 30 to 60 g; cocoa-containing nutrition bar is provided in a serving size from 15 to 40 g; the olive containing composition (sea salt version) in a serving size from 10 to 20 g; the olive containing composition (garlic version) in a serving size from 10 to 20 g; kale cracker composition is provides in a serving size from 30 to 60 g; In another variation, the kale cracker compositions are provided in a serving size from 20 to 50 g; the vegetable soup compositions are provided in a serving size from 20 to 50 g; the mushroom soup compositions are provided in a serving size from 20 to 50 g; the tomato soup compositions are provided in a serving size from 20 to 50 g; the bean-containing minestrone soup compositions are provided in a serving size from 20 to 50 g; the quinoa-containing minestrone soup compositions are provided in a serving size from 20 to 50 g; the pumpkin soup compositions are provided in a serving size from 20 to 50; the first vegetable both compositions are provided in a serving size from 5 to 15; the second vegetable both compositions are provided in a serving size from 3 to 15; and Energy Drink composition is provided in serving size of 1 to 5 oz.

Typically, in the FMD protocol the usual diet of the subjects is substituted for a predefined number of days (e.g., 5 days), in which the subject drinks plenty of water. In a refinement, the predetermined number of days is 3, 4, 5, 6, 7, 8, 9, or 10 days. For normal weight subjects (Body Mass Index between 18.5 and 25), the fasting-mimicking diet component is administered once a month (typically for 5 days), while for the next 25-26 days, the subject receives the re-feeding diet component. This first timing sequence may only be applied for the first 3 months. In a refinement thereof, the subject subsequently receives the fasting-mimicking diet component for 5 days and the re-feeding diet component for about 85 days continuing with a 5-day cycle of fasting-mimicking diet component followed by 85 days of re-feeding diet component. The subject weight is monitored so that the subject re-acquires at least 95% of the weight lost during the administration of the fasting-mimicking diet component, before starting the new cycle (for normal weight subjects). In overweight subjects, a weight loss following FMD cycles is admissible as long as it is well tolerated and the weight of the subject does not drop below the normal BMI range.

In accordance with the fasting-mimicking diet protocol, the subject is fed with food with a high content of monounsaturated and polyunsaturated fats and a reduced content of proteins and sugars (>40% calories coming from fat). This is because a diet based on these foods has beneficial effects that are similar to those of fasting⁸.

In a variation of the method and use herein, the human subject performs daily muscle training during the second time period. Such daily muscle training generally involves a total daily energy expenditure of 50-4000 kcal/day, preferably 100-2000 kcal/day, depending on the health conditions and the age of the human subject. In particular, for healthy young subjects with an athletic build, the daily muscle training generally involves a total daily energy expenditure of 1500-3500 kcal/day, and typically about 2000-3000 kcal/day. The daily muscle training for elderly human subjects (e.g., greater than 65 years of age) and/or human subjects suffering from debilitating diseases (such as, e.g., tumoral and metabolic diseases) generally involves a total daily energy expenditure of 50-1000 kcal/day, and typically about 100-500 kcal/day.

The following examples and discussion illustrate the various embodiments of the present invention. Those skilled in the art will recognize many variations that are within the spirit of the present invention and scope of the claims.

Within a clinical study of an FMD by L-Nutra (Prolon-NCT03595540), the Applicants surprisingly found that monthly cycles of the FMD (coupled to a diet with an adequate protein and calorie content, as provided by an appropriate re-feeding component, and to a daily muscle training, that was prescribed between FMD cycles) are associated with a significant increase in absolute lean body mass, including muscle mass, as confirmed by CT scan analysis.

The FMD was well tolerated by the enrolled patients, and only G1-2 adverse events (AEs; NCI CTCAE 5.0) were recorded (particularly headache and fatigue). Thus, periodic cycles of an FMD are a new approach to enhance lean body mass, possibly via regenerative effects triggered in muscle tissue^{1,2}.

Within a clinical study of monthly cycles of the FMD Prolon by L-Nutra in patients with cancer that has been conducted at the University of Genova, Italy (NCT03595540), 24 patients with HR+BC were enrolled. In addition to other clinical data, body weight, handgrip, as well as by bio-impedance parameters of these patients (e.g., phase angle—a correlate of lean body mass and an important prognostic factor-, fat-free mass and fat mass) have been recorded.

The FMD was found to be feasible and well-accepted by patients with only G1-2 AEs being recorded in this trial (typically headache, fatigue, and diarrhea). The FMD has been prescribed together with a regimen of light/moderate physical activity and a re-feeding component consisting of a fish-vegetarian (pesco-vegetarian) diet with an adequate protein content to be followed between FMD cycles,

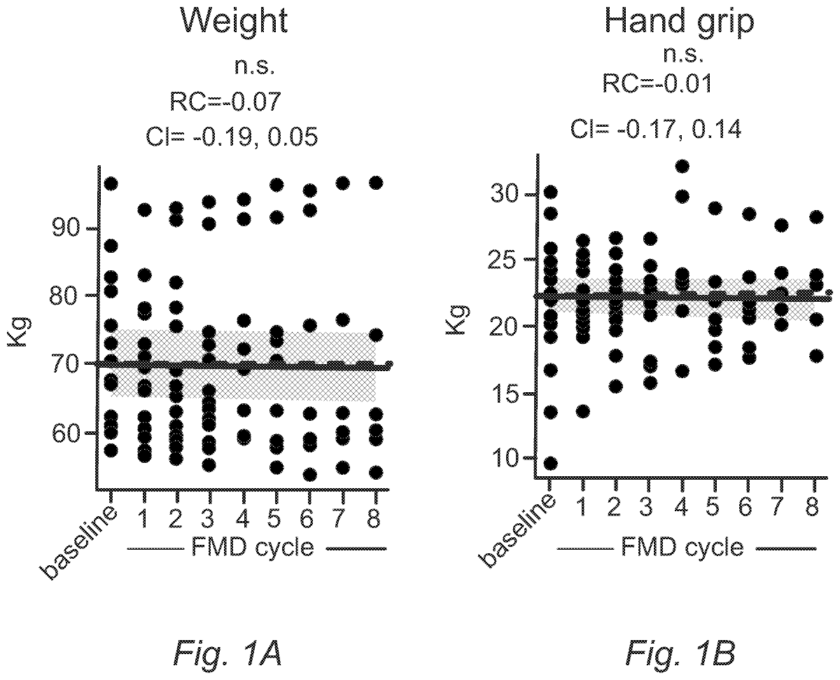

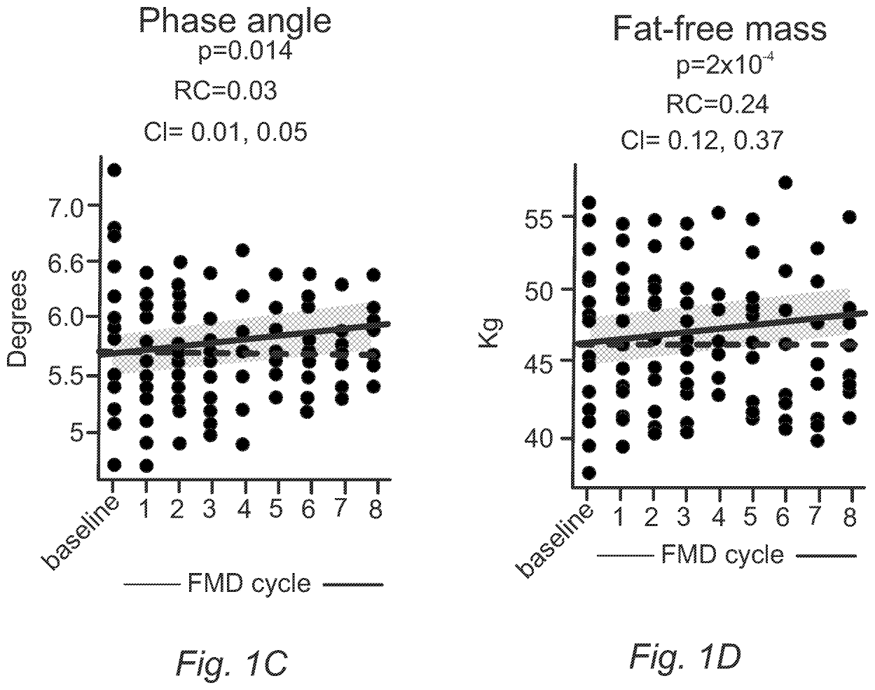

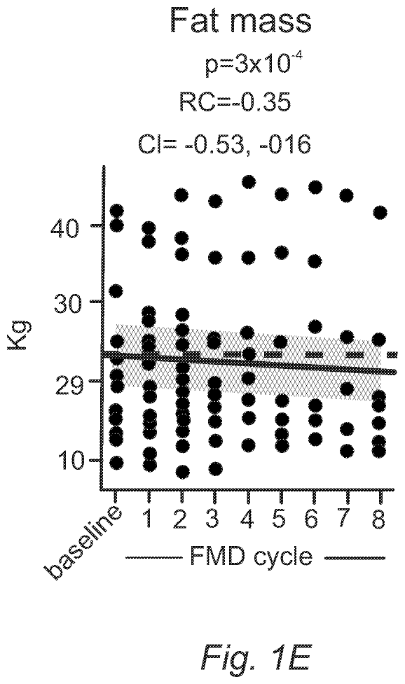

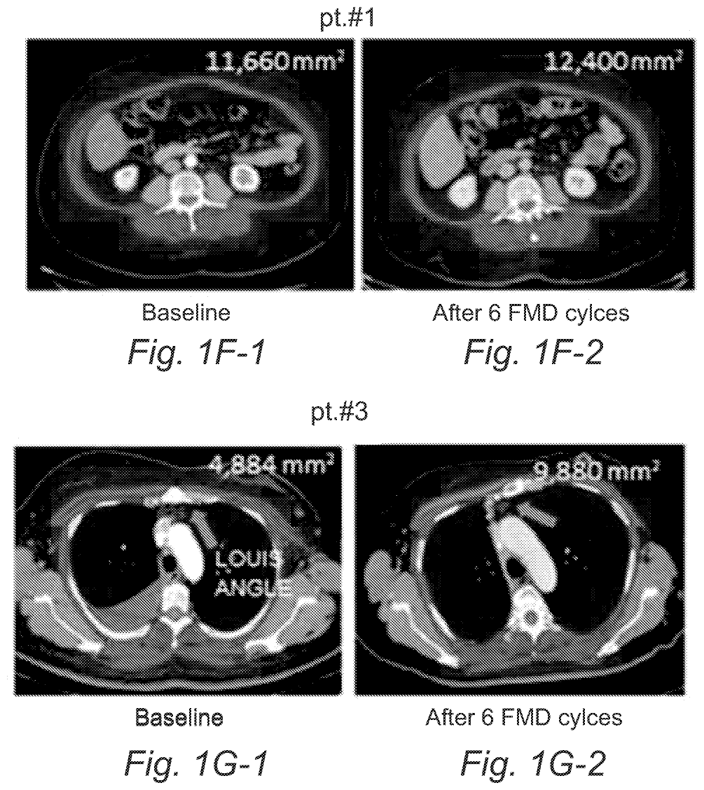

Patients received an average of 6.8 FMD cycles, with some of them receiving up to 14 FMD cycles and still remaining on trial. Patients receiving multiple FMD cycles maintained stable body weight and handgrip (FIG. 1a,b). Their bioimpedance phase angle and fat-free mass increased over time, while their fat mass decreased (FIG. 1a-e). These findings were confirmed by abdominal or thoracic CT scan analyses in those patients for whom CT scans were available (FIG. 1f, g).

Moreover, the use of the diet composition according to the present invention solves the problem of increasing lean body mass/muscle mass by an approach that simultaneously lowers cardiovascular risk factors and risk factors for aging-associated disorders³.

Of course, the use of the diet composition according to the present invention is suitable for increasing lean body mass/muscle mass not only in patients affected by tumoral diseases or in elderly subjects but also in healthy subjects, irrespective of their age.

Clinical Studies of FMDs in Patients Undergoing ET for HR+BC

The NCT03595540 clinical trial was conducted at the IRCCS Ospedale Policlinico San Martino. This trial consisted of a single-arm phase II clinical study of an FMD (Prolon, by L-Nutra, Los Angeles, Calif.) in 60 patients with solid or hematologic tumors undergoing active cancer treatment.

The study was aimed at assessing feasibility, safety, and effects on patient nutritional status of an FMD in patients with different cancer types and concomitant anticancer treatment.

An amendment to the protocol (which includes the possibility of using imaging studies that are otherwise routinely prescribed for disease monitoring, e.g., CT scans, for body composition evaluation) was approved by the Ethics Committee of the Regione Liguria on Apr. 8 2019 (amendment #27). The FMD tested was described elesenwhere^{1,3}.

Throughout the clinical study, patients have received dietary counseling for the intervals between FMD cycles, aiming at providing an appropriate intake of proteins (1.5 g/kg ideal weight/day, primarily from seafood and legumes), essential fatty acids, vitamins and minerals^{4,5} and have also been invited to perform light/moderate daily muscle training (e.g. 120-145 kcal/day; as allowed by their medical condition; (https://docs.google.com/presentation/d/1szaRW4t-pZQI17o2Pe0747FsUEOVWWiA6BHja0p8H_0/edit#slide=id.g34ad797184_0_0) to enhance muscle anabolism)⁶.

Additional information on this trial is available at: https://clinicaltrials.gov/ct2/show/NCT03595540; the entire disclosure of which is hereby incorporated by reference.

CT Scan-Based Body Composition Analysis

CT scans of Pt.#1 and Pt.#3 were acquired with different CT scanners. Both 1.25-mm and 5-mm slice thickness with standard body kernel were available. The whole body was scanned from the lung apex to the pubic symphysis (Pt.#1).

Reconstructed axial images with both a 1.25-mm and a 5-7 mm slice thickness were analyzed using the software installed on the workstations of the IRCCS Ospedale Policlinico San Martino Radiology Department (Suite-Estensa 1.9-Ebit-Esaote Group Company, 2015).

The third lumbar vertebra (L3), at the level in which both transverse processes are clearly visible, was the bony landmark for the estimation of total muscle area and subcutaneous fat. If abdominal CT scans were not available, but only thoracic CT was present (Pt.#3), estimation of total muscle area (red areas) and fat at the level of the Louis angle (manubriosternal joint that lies at the level of the second costal cartilage) at baseline and after repeated FMD cycles were done according to Rossi et al.⁷

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

1. Brandhorst, S. et al. A Periodic Diet that Mimics Fasting Promotes Multi-System Regeneration, Enhanced Cognitive Performance, and Healthspan. Cell metabolism 22, 86-99, doi:10.1016/j.cmet.2015.05.012 (2015).
2. Olguin et al. Reciprocal inhibition between Pax7 and muscle regulatory factors modulates myogenic cell fate determination. J. Cell. Biol. 2007; 177:769-779.
3. Wei, M. et al. Fasting-mimicking diet and markers/risk factors for aging, diabetes, cancer, and cardiovascular disease. Sci Transl Med 2017 Feb. 15; 9(377).
4. Arends, J. et al. ESPEN guidelines on nutrition in cancer patients. Clin Nutr 36, 11-48, doi:10.1016/j.clnu.2016.07.015 (2017).
5. Arends, J. et al. ESPEN expert group recommendations for action against cancer-related malnutrition. Clin Nutr 36, 1187-1196, doi:10.1016/j.clnu.2017.06.017 (2017).
6. Reidy, P. T. et al. Protein blend ingestion following resistance exercise promotes human muscle protein synthesis. The Journal of nutrition 143, 410-416, doi:10.3945/jn.112.168021 24 (2013).
7. Rossi, F., Valdora, F., Barabino, E., Calabrese, M. & Tagliafico, A. S. Muscle mass estimation on breast magnetic resonance imaging in breast cancer patients: comparison between psoas muscle area on computer tomography and pectoralis muscle area on MRI. European radiology 29, 494-500, doi:10.1007/s00330-018-5663-0 (2019).
8. Safdie F, Brandhorst S, Wei M, Wang W, Lee C, Hwang S, Conti PS, Chen TC, Longo VD: Fasting enhances the response of glioma to chemo- and radiotherapy. PloS one 2012, 7(9):e44603.

1. A method for enhancing lean body mass and/or muscle mass in a human subject in need thereof,
administering a fasting-mimicking diet component for a first time period of 24 to 190 hours, the fasting-mimicking diet component providing less than 50% of the normal calorie intake of the human subject with both protein restriction and sugar restriction; and
administering a re-feeding diet component to the human subject for a second time period, the re-feeding diet component providing 60-100% of the normal calorie intake of the human subject,
wherein the fasting-mimicking diet component and the re-feeding diet component are administered for multiple cycles.

2. The method of claim 1, wherein the fasting-mimicking diet component includes rations for a fasting-mimicking diet to be administered for the first time period to a subject, the fasting-mimicking diet providing the subject with at most 50 percent of a subject's normal caloric intake for a first day to a fifth day, the fasting-mimicking diet being a low protein diet that provides less than 28 g of proteins on the first day and less than 18 g of proteins on the second to fifth days wherein the rations provide less than 30 g of sugar on the first day, less than 20 g of sugar on the second to fifth days, and less than 12 g of saturated fats on the first day and less than 6 grams of saturated fats on the second to fifth days.

3. The method of claim 1, wherein the first time period is from 48 to 150 hours and the second time period is from 5 to 60 days.

4. The method of claim 1, wherein the first time period is of 120 hours and the second time period is of 25-26 days.

5. The method of claim 1, wherein the fasting-mimicking diet component provides 10-50% of the normal calorie intake of the human subject.

6. The method of claim 1, wherein the fasting-mimicking diet component provides 10-25% of the normal calorie intake of the human subject.

7. The method of claim 1, wherein the fasting-mimicking diet component provides 10-15% of the normal calorie intake of the human subject.

8. The method of claim 1, wherein the human subject undergoes at least three cycles,
more preferably at least five cycles, of reduced calorie intake.

9. The method of claim 1, wherein the fasting-mimicking diet component comprises foods with a high content of monounsaturated and polyunsaturated fats and a reduced content of proteins and sugars, at least 40% of calories being derived from fats.

10. The method of claim 1, wherein the fasting-mimicking diet component provides less than 800 kcal/day.

11. The method of claim 1, wherein the fasting-mimicking diet component provides less than 400 kcal/day.

12. The method of claim 1, wherein the fasting-mimicking diet component comprises proteins in an amount that is less than 15% of the total calories provided by the fasting-mimicking diet component.

13. The method of claim 1, wherein the fasting-mimicking diet component comprises sugars in an amount that is less than 15% of the total calories provided by the fasting-mimicking diet component.

14. The method of claim 1, wherein the fasting-mimicking diet component provides the human subject with 9 to 15 kcal/kg of body weight/day on day 1, and 6 to 10 kcal/kg of body weight/day on days 2 to 5.

15. The method of claim 1, wherein the fasting-mimicking diet component comprises at least 60% calories from fatty acids, 2-5% calories from glycerol, and up to 5% calories from plant-based proteins and a maximum of 35% calories from carbohydrates.

16. The method of claim 1, wherein the fasting-mimicking diet component comprises complex carbohydrates from plant sources.

17. The method of claim 1, wherein at least 50% of the calories from fatty acids are (Original) from coconut oil and tree nuts.

18. The method of claim 1, wherein the human subject performs a daily muscle training during the second time period.

19. The method of claim 18, wherein the daily muscle training involves a total daily energy expenditure of 50-4000 kcal/day.

20. The method of claim 1, wherein the fasting-mimicking diet component includes less than 30 g of sugar on day 1 and less than 20 g of sugar on days 2-5. The fasting-mimicking diet component includes less than 28 g of proteins on day 1 and less than 18 g of proteins on days 2-5, mostly or completely from plant based sources. The fasting-mimicking diet component includes between 20 and 30 grams of monounsaturated fats on day 1 and 10-15 grams of monounsaturated fats on days 2-5. The fasting-mimicking diet component includes between 6 and 10 grams of polyunsaturated fats on day 1 and 3-5 grams of polyunsaturated fats on days 2-5. The fasting-mimicking diet component includes less than 12 g of saturated fats on day 1 and less than 6 grams of saturated fats on days 2-5.

21. The method of claim 1, wherein the fasting-mimicking diet component provides 1, 1, 2, or 3 servings of soup compositions per day, the soup compositions providing from 90 to 120 kcal per serving, 1 to 5 grams of fat, 15 to 30 grams of carbohydrates, and 2 to 7 grams of protein.

22. The method of claim 21, wherein the fasting-mimicking diet component provides 1, 2, or 3 nutrition bars per day of the FMD protocol, the nutrition bars each providing from 150 to 300 kcal per serving, 15 to 30 grams of fat, 5 to 20 grams of carbohydrates, and 2 to 7 grams of protein.

23-37. (canceled)
